(19) United States
(12) Patent Application Publication
(10) Pub. No.: US 2007/0290394 A1
(43) Pub. Date: Dec. 20, 2007

(54) METHOD AND STRUCTURE FOR FORMING SELF-PLANARIZING WIRING LAYERS IN MULTILEVEL ELECTRONIC DEVICES

(75) Inventors: Toshiharu Furukawa, Essex Junction, VT (US); Mark C. Hakey, Fairfax, VT (US); Steven J. Holmes, Guilderlane, NY (US); David V. Horak, Essex Junction, VT (US); Charles W. Koburger, Delmar, NY (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/425,210

(22) Filed: Jun. 20, 2006

(51) Int. Cl. B28B 1/48

(52) U.S. Cl. 264/154; 428/292.1

(57) ABSTRACT

A method for forming a self-planarizing wiring layer for a semiconductor device includes forming a mat of filament material over a semiconductor substrate, and infusing the mat with a conductive material formed at a thickness substantially corresponding to the thickness of the mat of filament material. The mat is then patterned so as to expose regions where conductive wiring is not to be present, and the infused conductive material is removed from the exposed regions. The exposed regions of the mat are infused with an insulating material, formed at a thickness substantially corresponding to the thickness of the mat of filament material.

### BACKGROUND

The present invention relates generally to semiconductor device processing techniques, and, more particularly, to a method and structure for forming self-planarizing wiring layers in multilevel electronic structures, such as semiconductor devices.

In semiconductor manufacturing, the formation of multi-level wiring continues to be a major yield and cost hurdle for integrated circuits (IC) manufacturers. One sector that contributes major problems to these processes is the area of chemical mechanical polishing or planarization (CMP).

Integrated circuits are typically formed on substrates, particularly silicon wafers, by the sequential deposition of conductive, semiconductive or insulative layers. After each layer is deposited, it is etched to create circuitry features. Damascene processing is one common method for fabricating planar copper interconnects. Damascene wiring interconnects (and/or studs) are formed by depositing a dielectric layer on a planar surface, patterning the dielectric layer using photolithography and reactive ion etching (RIE), and then filling the formed recesses with conductive metal. The excess metal is then removed by CMP, leaving the troughs or channels filled with metal.

CMP typically requires that the substrate be mounted on a carrier or polishing head. The exposed surface of the substrate is placed against a rotating polishing pad. The polishing pad may be either a “standard” or a fixed-abrasive pad. A standard polishing pad has durable roughened surface, whereas a fixed-abrasive pad has abrasive, submicron particles (e.g., ceria (CeO₂)) embedded in a containment media. The carrier head provides a controllable load (i.e., pressure) on the substrate to push it against the polishing pad. A polishing slurry, including at least one chemically reactive agent, and abrasive particles (if a standard pad is used) is supplied to the surface of the polishing pad.

In any case, CMP is an expensive undertaking, in terms of capital (i.e., tooling), consumables (e.g., chemicals and polishing pads), and processing time. In addition, loading issues can result in buildup of topographic steps for certain chip designs. These topographic steps can manifest themselves as residual metal in low spots, and sometimes as an inability to focus critical levels in both the highest and lowest areas concurrently, thereby resulting in yield loss. Fill shapes and cheesing have been employed to alleviate the topography problems, but result in additional mask design complexity, decrease conductivity, and do not alleviate the problem. Accordingly, it would be desirable to be able to devise a way to form planarized wiring structures for semiconductor devices that avoids the use of polishing steps.

### SUMMARY

The foregoing discussed drawbacks and deficiencies of the prior art are overcome or alleviated by a method for forming a self-planarizing wiring layer for a semiconductor device. In an exemplary embodiment, the method includes forming a mat of filament material over a semiconductor substrate, and infusing the mat with a conductive material formed at a thickness substantially corresponding to the thickness of the mat of filament material. The mat is then patterned so as to expose regions where conductive wiring is not to be present, and the infused conductive material is removed from the exposed regions. The exposed regions of the mat are infused with an insulating material, formed at a thickness substantially corresponding to the thickness of the mat of filament material.

In another embodiment, a wiring layer structure for a substrate includes a mat of filament material, with a first portion of the filament material having a conductive material infused therein, and a second portion of the filament material having an insulating material infused therein.

In still another embodiment, a method for forming a self-planarizing wiring layer includes forming a mat of filament material over a substrate, initially infusing the mat with one of a conductive material or an insulating material, at a thickness substantially corresponding to the thickness of the mat of filament material. The mat is patterned so as to expose selected regions thereof, and the initially infused material is removed from the exposed regions. The exposed regions of the mat are infused with the other of the conductive material or the insulating material, at a thickness substantially corresponding to the thickness of the mat of filament material.

### BRIEF DESCRIPTION OF THE DRAWINGS

Referring to the exemplary drawings wherein like elements are numbered alike in the several Figures:

FIGS. 1 through 6 are a sequence of process flow steps illustrating a method for forming self-planarizing wiring layers in semiconductor devices, in accordance with an embodiment of the invention.

### DETAILED DESCRIPTION

Disclosed herein is a method and structure for forming self-planarizing wiring layers in semiconductor devices. Briefly stated, a backbone material is utilized to define a desired thickness for both conductive and insulative regions in a given wiring or via level. The backbone is characterized by a mat of filaments that may be processed (post deposition) to form an insulator in regions where electrical conductivity is not desired and, in other regions, processed (post deposition) to form a conductor where electrical conductivity is desired. The mat has a sufficient density of filaments so as to maintain a well-defined, planar composite material that enables deposition of thin layers of other materials (e.g., metal, oxides) to fill the inter-filament spaces without excessively thick deposition processes. At the same time, the deposited material within the inter-filament spaces may also be selectively removed by etching from selected locations. In an exemplary embodiment, carbon nanotubes are used as the backbone material.

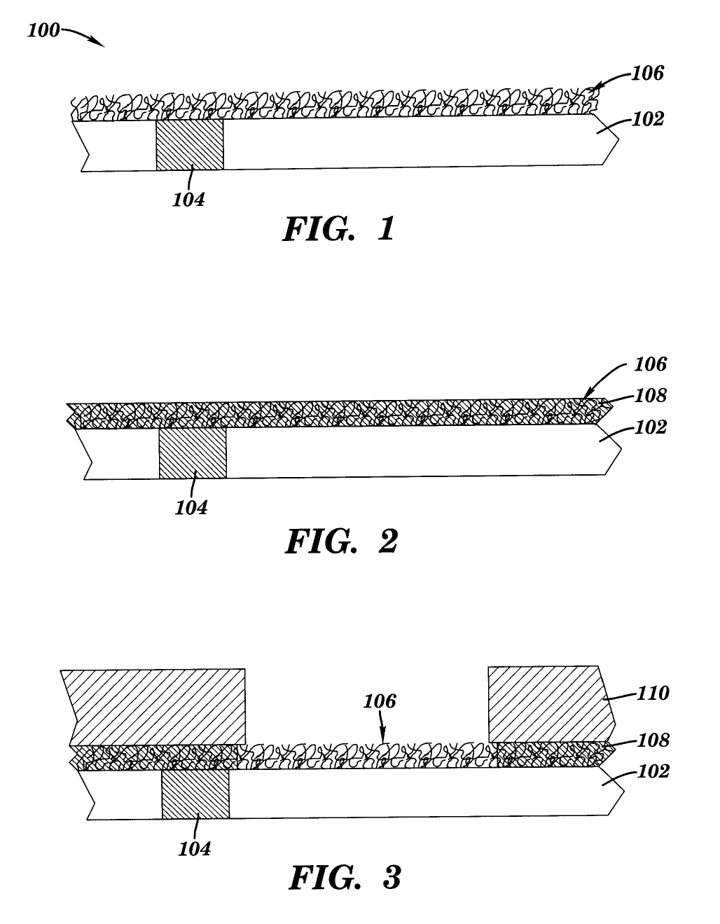

Referring now to FIGS. 1 through 6, there is shown a sequence of process flow steps illustrating a method for forming self-planarizing wiring layers in semiconductor devices, in accordance with an embodiment of the invention. As shown in FIG. 1, a back end of line (BEOL) region of a semiconductor device 100 is illustrated. In particular, a via portion of a completed interlevel dielectric (ILD) layer 102 has a via 104 formed therein. The via 104 and ILD may be formed by conventional means (e.g., damascene) or by the process described herein. Alternatively, completed ILD layer 102 could also represent a semiconductor substrate having active devices formed therein. In any case, a carbon nanotube (CNT) mat 106 is then formed over the ILD layer 102 and via 104. The nanotube material may be made from single wall nanotubes or multiple wall nanotubes, and can either be initially semiconducting or conducting. Further, the CNT mat 106 may be applied via casting solvent spin-on, and then dried. An exemplary deposition thickness of the CNT mat 106 is on the order of about 50 to about 250 nanometers (nm).

As shown in FIG. 2, the CNT mat 106 is then infused with a conductive material layer 108. Since a solid conductive film is desirable, the layer 108 may be a deposited material having a low melting temperature (e.g., aluminum), which is then subject to a laser or furnace reflow treatment, such that the conductive material fills the CNT mat 106. Where a thick conductive layer 108 is employed, then the fill step is complete at this point. Alternatively, plating of the conductive layer 108 using an initially deposited thickness of the material may also produce a voidless fill. If the conductive layer is selectively plated (i.e., from a seed layer up), the thickness range is about the same as the CNT mat 106. Otherwise, if directly plated on the nanotubes, the thickness may be roughly half that of the CNT tube-to-tube spacing (e.g., about 20-100 nm). In either instance, the final resulting thickness of the conductive layer 108 corresponds to the top surface of the CNT mat 106, or slightly below or slightly above (as in the case of non-selective plating or CVD).

In FIG. 3, the resulting structure is patterned with a photoresist material 110 so as to expose portions of the CNT mat 106 and conductive layer 108 corresponding to locations where wiring is not desired. Then, the exposed conductive layer material 108 is removed by etching, leaving only the CNT mat 106 in the exposed region. Some isotropic etching may also be implemented in order to clean out regions beneath the nanotubes of the CNT mat 106. Furthermore, because the exposed region shown in FIG. 3 is intended to be an insulating portion of the semiconductor device, the exposed nanotubes of the CNT mat 106 are then subjected to a fluorine treatment (e.g., by a downstream fluorine plasma) so as eliminate any conductive properties of the CNT mat 106 at that location, while maintaining the physical structure of CNT mat 106. Additional information regarding the fluorination of CNT material may be found in A. Hamwi, H. Alvergnat, S. Bonamy and F. Béguin, “Fluorination of carbon Nanotubes”, Carbon, Vol. 35, No. 6, pp. 723-728 (1997), the contents of which are incorporated by reference herein in their entirety.

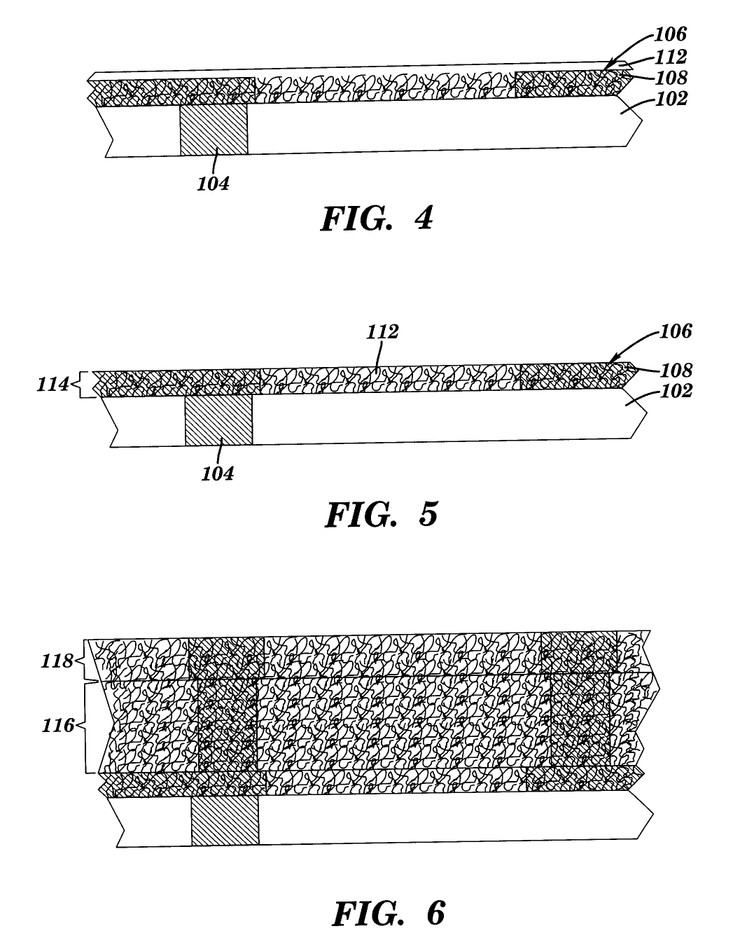

Referring next to FIG. 4, the resist layer is removed and the fluorinated portion of the CNT mat 106 is infused with an insulating material 112 (e.g., SiO₂), such as by chemical vapor deposition (CVD) or atomic layer deposition (ALD), for example. As opposed to the infusion of conductive material in FIG. 2, a solid fill of insulating material 112 is not required, and in fact is not particularly desirable since the presence of air within the insulating material 112 will decrease the dielectric constant thereof. Then, as shown in FIG. 5, the excess insulating material is etched back to the top of the CNT mat 106. A wiring level 114 is thus formed from a CNT mat 106 having conductive material 108 infused therein at wiring locations and insulating material 112 infused therein at insulating locations. Moreover, the portions of the CNT mat 106 having insulating material 112 therein are rendered nonconductive by the fluorine treatment. As will be appreciated, the wiring level 114 is completed without the use of CMP.

Finally, FIG. 6 illustrates the formation of an additional via layer 116, and an additional wiring layer 118 using the above described technique. Depending upon the thickness of a given wiring/via level, the CNT material can be deposited as several discrete thinner layers, infusing material following each nanotube deposition. This approach can also reduce void percentage. In addition, as each successive CNT layer is formed, the density of the nanotubes can be increased. This will result in a more solid top insulating layer, with porous lower levels.

Although the exemplary process flow begins with a conductive material infused within the CNT mat, followed by selective removal of the conductive material, selectively lowering the conductivity of the CNT material and infusion of insulating material, it is also contemplated that a formed CNT mat could be first infused with the insulating material. Selected locations of the infused CNT mat would then be etched to remove the insulating material, followed by infusion of conductive material. However, in this variation, the CNT mat would likely initially comprise insulating nanotubes and thus the wiring locations receiving a subsequent infusion of conductive material would have a lower conductivity with respect to the above described embodiment. Alternatively, additional processing steps can be undertaken to remove fluorination of the portions of the CNT mat to receive conductive material infusion.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming a self-planarizing wiring layer for a semiconductor device, the method comprising:
forming a mat of filament material over a semiconductor substrate;
infusing said mat with a conductive material, said conductive material formed at a thickness substantially corresponding to the thickness of said mat of filament material;
patterning said mat with said conductive material infused therein so as to expose regions where conductive wiring is not to be present;
removing said infused conductive material from said exposed regions; and
infusing said exposed regions of said mat with an insulating material, said insulating material formed at a thickness substantially corresponding to the thickness of said mat of filament material.

2. The method of claim 1, wherein said filament material comprises carbon nanotubes.

3. The method of claim 2, wherein said carbon nanotubes are single walled.

4. The method of claim 2, wherein said carbon nanotubes are multiple walled.

5. The method of claim 2, further comprising converting said filament material of said exposed regions of said mat from conductive material to insulating material prior to said infusing said exposed regions of said mat with an insulating material.

6. The method of claim 5, wherein said converting said filament material from conductive material to insulating material comprises exposing said filament material to fluorine.

7. The method of claim 1, wherein said infused conductive material is removed from said exposed regions by etching.

8. The method of claim 1, wherein said infused conductive material comprises aluminum.

9. The method of claim 8, wherein said conductive material is infused by one of: electroplating on a seed layer and directly electroplating on said filament material.

10. The method of claim 1, wherein said infused insulating material comprises silicon dioxide.

11. The method of claim 10, wherein said insulating material is infused by one of: chemical vapor deposition and atomic layer deposition.

12. The method of claim 2, wherein said carbon nanotube mat is formed by casting solvent spin-on.

13. A wiring layer structure for a substrate, comprising:
a mat of filament material;
a first portion of said filament material having a conductive material infused therein; and
a second portion of said filament material having an insulating material infused therein.

14. The structure of claim 13, wherein said filament material comprises carbon nanotubes.

15. The structure of claim 14, wherein said carbon nanotubes are single walled.

16. The structure of claim 14, wherein said carbon nanotubes are multiple walled.

17. A method for forming a self-planarizing wiring layer, the method comprising:
forming a mat of filament material over a substrate;
initially infusing said mat with one of a conductive material or an insulating material, at a thickness substantially corresponding to the thickness of said mat of filament material;
patterning said mat so as to expose selected regions thereof,
removing the initially infused material from said exposed regions; and
infusing said exposed regions of said mat with the other of said conductive material or said insulating material, at a thickness substantially corresponding to the thickness of said mat of filament material.
